(19) United States
(12) Patent Application Publication
(10) Pub. No.: US 2010/0116159 A1
(43) Pub. Date: May 13, 2010

(54) Offset Printing Unit with Plate Cylinder Drive

(76) Inventor: Larry Hines, Effingham, IL (US)

Correspondence Address: Baker Botts L.L.P, 910 Louisiana Street, One Shell Plaza, HOUSTON, TX, 77002, US

(21) Appl. No.: 12/617,201

(22) Filed: Nov. 12, 2009

Related U.S. Application Data
(60) Provisional application No. 61/199,061, filed on Nov. 13, 2008.

(51) Int. Cl. B41F 7/02; B41F 3/34

(52) U.S. Cl. 101/217; 101/492

(57) ABSTRACT

An offset printing unit has a first plate cylinder, a first blanket cylinder, at least one first inker roller, and a motor that drives the plate cylinder. The first plate cylinder supports a first printing plate and drive the first blanket cylinder. The first blanket cylinder supports a first printing blanket, rollingly engages the first plate cylinder, and rollingly engages a substrate. The at least one first inker roller supplies ink to the first plate and blanket cylinders and rollingly engages the first plate cylinder.

### CROSS-REFERENCE TO RELATED APPLICATIONS

This application claims benefit of U.S. Provisional Patent Application Ser. No. 61/199,061, filed Nov. 13, 2008, which is herein incorporated by reference in its entirety.

### BACKGROUND

The present invention relates to offset printing units, and, at least in some embodiments, to novel drive train configurations for offset printing units and their associated methods of use.

A conventional offset printing unit typically includes a rotationally supported plate cylinder (or “printing cylinder”) carrying a printing plate. The printing plate has oleophilic surfaces defining an image area, and hydrophilic surfaces defining a non-image area. An inker (or “inker roller”) applies ink to the printing plate. The ink collects on the oleophilic surfaces to form an image which transfers to a blanket cylinder, and which, in turn, transfers to media, such as a web or sheet of paper, plastic, metal, or other substrate running between the blanket cylinder and an impression cylinder. The grouping of a plate cylinder and a blanket cylinder is often referred to as a “cylinder couple” or a “couple.” By transferring the image first from the printing plate to a blanket roller, and then to the web, the printing plate does not directly print the image on the web, hence the term “offset” printing. Moreover, by placing a cylinder couple (with accompanying inkers) on both sides of the paper, images are applied to both sides of the paper simultaneously, often referred to as perfecting printing. Application of an image on only a single side of the paper, on the other hand, is commonly known as non-perfecting printing.

The circumference of the rotating cylinders determines the length of each repeated pattern printed onto the web passing therethrough. Therefore, in order to permit a press to be modified to permit printing of different sized repeated pattern, plate and blanket cylinders of selected circumferences are used to vary the repeat size provided by the press. Quality printing requires at least some degree of accurate synchronization of the cylinders. The cylinders may also be configured to permit throw off (separation for accessibility during routine maintenance and/or to allow the web to be fed therethrough). During this process, the precisely set contact stripe between the cylinders may be lost.

The gear teeth that mesh between a driving gear and a driven gear tend to separate circumferentially (contact forms from one gear flank to another) when the gears rotate during the printing process. Thus, in a printing unit, the gear teeth on a driving gear, fixed to a blanket cylinder, tend to separate circumferentially from the gear teeth on a driven gear, fixed to an adjoining plate cylinder, when the cylinders rotate during printing. The circumferential separation experienced by such gear teeth in a printing unit may cause defects in the printed product.

Typically, a plate cylinder of a printing unit may be circumferentially adjusted, and/or laterally adjusted. Poor quality such as color to color register variation or doubling of a printed image on a web or sheet of paper or material occurs when, among other things, the plate cylinder rotationally moves with respect to the blanket cylinder during the previously described separation of their respective gear teeth, the rate of movement per revolution of the plate cylinder varies as a function of the rate of revolution, i.e. the rotational speed, of the plate cylinder. Doubling occurs when the blanket cylinder prints the same image onto a web or sheet more than once, or prints a doubled image. One printing may result from the residual (leftover) ink of an image applied by the printing plate on the plate cylinder to one location on the blanket cylinder during one revolution of the blanket cylinder, as the ink remains on the blanket cylinder after the one revolution of the blanket cylinder. Another printing may be from ink of the same image applied by the printing plate on the plate cylinder to another location on the blanket cylinder after the one revolution of the blanket cylinder and after adjustment of the plate cylinder. The image on the web or sheet from the one printing and the image on the web or sheet from the other printing may vary from each other enough to give the appearance of a double image, i.e. doubling of an image. Doubling results in poor quality and/or wasted paper. Further, increased plate/blanket gear tooth contact load increases the operating margin which decreases register variation and/or doubling. There can be more than one residual image.

### SUMMARY

The present invention relates to offset printing units, and, at least in some embodiments, to novel drive train configurations for offset printing units and their associated methods of use.

In some embodiments, an offset printing unit comprises: a first plate cylinder configured to support a first printing plate during printing; a first blanket cylinder configured to support a first printing blanket during printing, rollingly engage the first plate cylinder during printing, and rollingly engage a substrate during printing; at least one first inker roller configured to supply ink to the first plate and blanket cylinders during printing and rollingly engage the first plate cylinder during printing; and a first motor configured to drive the first plate cylinder during printing.

In some embodiments, a method of driving the offset printing unit comprises the steps of: driving the first plate cylinder with the first motor; and driving the first blanket cylinder with the first plate cylinder.

In some embodiments, a method of driving the offset printing unit comprises driving the first plate cylinder with the first motor; driving a second plate cylinder with a second motor; driving the first blanket cylinder with the first plate cylinder; and driving a second blanket cylinder with the second plate cylinder.

The features and advantages of the present invention will be apparent to those skilled in the art. While those skilled in the art may make numerous changes, such changes are within the spirit of the invention.

### BRIEF DESCRIPTION OF THE DRAWINGS

These drawings illustrate certain aspects of some of the embodiments of the present invention, and should not limit or define the invention.

FIG. 1 is a cross-sectional view of one embodiment of an offset printing unit;

FIG. 2 is a cross-sectional view of one embodiment of an offset printing unit;

FIG. 3 is an exploded view of one embodiment of an offset printing unit;

FIG. 4 is an exploded perspective view of one embodiment of an offset printing unit; and

FIG. 5 is a perspective, exploded view of an embodiment of a plate cylinder drive offset printing unit showing primary forces and torques.

### DESCRIPTION OF THE PREFERRED EMBODIMENTS

The present invention relates to offset printing units, and, at least in some embodiments, to novel drive train configurations for offset printing units and their associated methods of use.

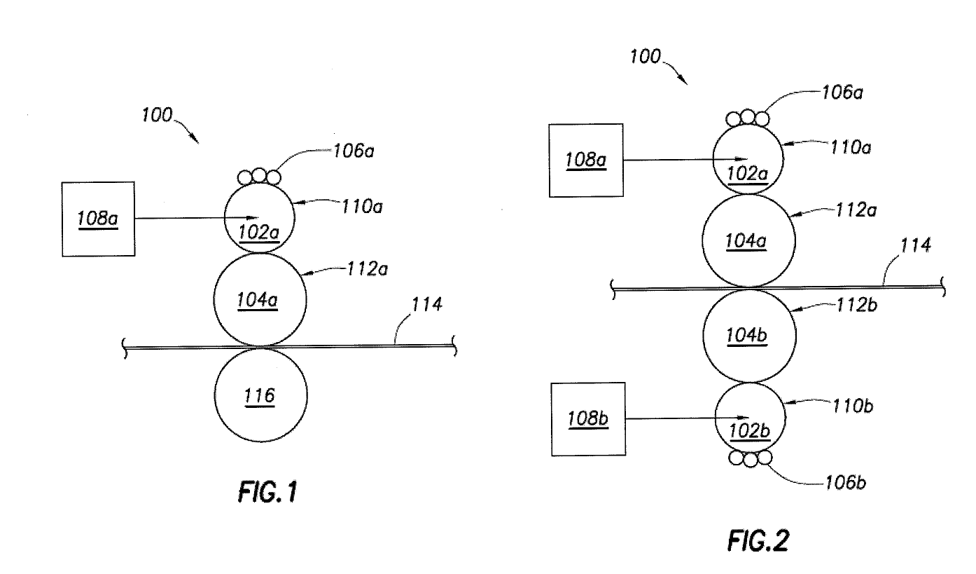

Referring to FIG. 1, in one embodiment offset printing unit 100 has at least one plate cylinder 102a, at least one blanket cylinder 104a, at least one set of inker rollers 106a, and at least one motor 108a. Plate cylinder 102a is configured to support printing plate 110a during printing, and to drive blanket cylinder 104a during printing. Blanket cylinder 104a is configured to support printing blanket 112a during printing, and to rollingly engage plate cylinder 102a and web 114 during printing. Inker rollers 106a are configured to supply ink to plate cylinder 102a and thus, to blanket cylinder 104a by rollingly engaging plate cylinder 102a during printing. Motor 108a is configured to drive plate cylinder 102a during printing. Optionally, impression cylinder 116 is configured to cooperate with blanket cylinder 104a to engage opposing sides of web 114 during printing. The configuration of FIG. 1 enables printing on one side of web 114.

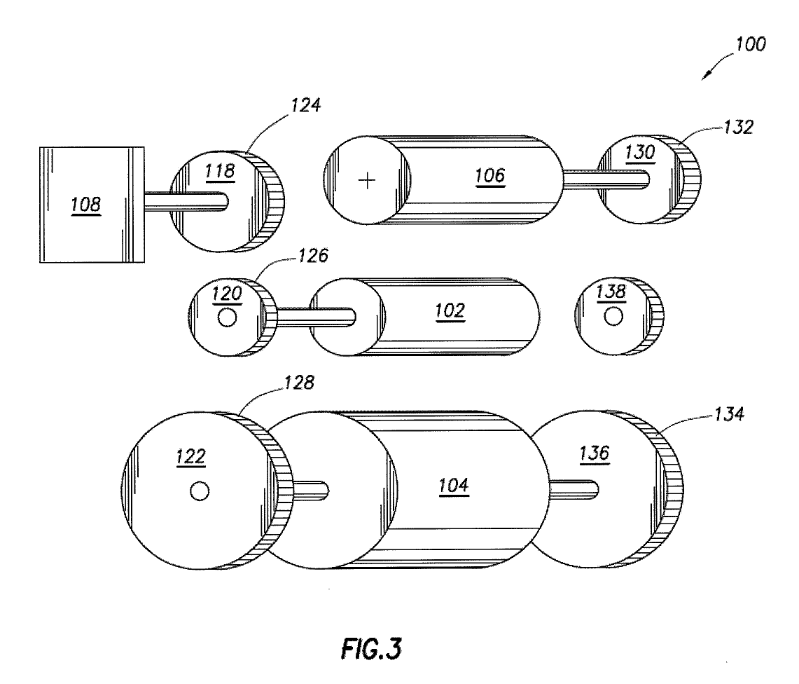

Referring now to FIG. 2, offset printing unit 100 is a unit configured to print both sides simultaneously, with an additional plate cylinder 102b, blanket cylinder 104b, set of inker rollers 106b, and/or motor 108b on an opposing side of web 114 from plate cylinder 102a, blanket cylinder 104a, inker rollers 106a and/or motor 108a. In this embodiment, impression cylinder 116 is omitted. Similar to the embodiment described above, the embodiment of FIG. 2 includes plate cylinders 102a and 102b configured to support printing plates 110a and 110b respectively during printing. Plate cylinders 102a and 102b are further configured to drive blanket cylinders 104a and 104b during printing. Blanket cylinders 104a and 104b are configured to support printing blankets 112a and 112b during printing. Blanket cylinders 104a and 104b are further configured to rollingly engage plate cylinders 102a and 102b and web 114 during printing. Inker rollers 106a and 106b are configured to supply ink to plate cylinders 102a and 102b and thus, to blanket cylinders 104a and 104b by rollingly engaging plate cylinders 102a and 102b during printing. Motors 108a and 108b are configured to drive plate cylinders 102a and 102b during printing. In the embodiment of FIG. 2, blanket cylinders 104a and 104b engage opposing sides of web 114 during printing.

Referring now to FIG. 3, offset printing unit 100 has motor gear 118, plate gear 120, and blanket gear 122. Motor gear 118 is preferably coaxial with motor 108 and rotable therewith. Motor gear 118 has motor gear teeth 124. Plate gear 120 is preferably coaxial with plate cylinder 102 and rotable therewith. Plate gear 120 has plate gear teeth 126 configured to meshingly engage motor gear teeth 124 and establish a driving connection between motor 108 and plate cylinder 102. Blanket gear 122 is preferably coaxial with blanket cylinder 104 and rotable therewith. Blanket gear 122 has blanket gear teeth 128 configured to meshingly engage plate gear teeth 126 and establish a driving connection between plate cylinder 102 and blanket cylinder 104. While FIG. 3 illustrates a single motor gear 118, plate gear 120, and blanket gear 122, any number of gears may be used to drive the various components. Additionally, offset printing unit 100 may include multiple motor gears 118, plate gears 120, and blanket gears 122 and associated teeth to correspond, for example, to motors 108a and 108b, plate cylinders 102a and 102b, and blanket cylinders 104a and 104b of FIG. 2. Further, the various gears and corresponding teeth may appear at either or both ends of the respective cylinders.

Referring still to FIG. 3, blanket cylinder 104 is configured to drive inker rollers 106 during printing. For example, inker gear 130 is coaxial with inker rollers 106 and rotable therewith. Inker gear 130 has inker gear teeth 132 configured to meshingly engage second blanket gear teeth 134 on second blanket gear 136 and establish a driving connection between blanket cylinder 104 and the inker rollers 106 during printing. This driving connection may be established in a number of ways. For example, a gear train may provide one or more intermediate gears (e.g., gears 138) having teeth to provide one or more of the meshing engagements. Likewise, a similar configuration could be used to allow an additional blanket cylinder to drive additional inker rollers on an opposing side of a web in a two-sided printing operation. In other embodiments, gear 118 may be eliminated and motor 108 may drive directly into plate gear 120.

In another embodiment, the gear teeth may be minimized or even eliminated and belts may drivingly connected to motor 108 and plate cylinder 102 and/or any of the other components of offset printing unit 100.

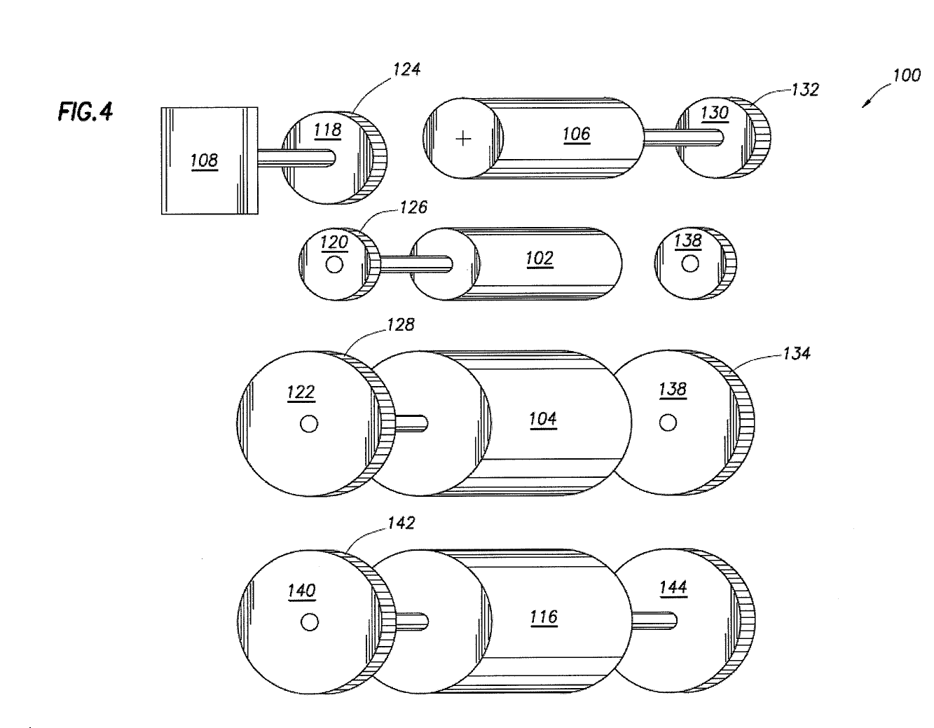

Referring now to FIG. 4, in a single-sided printing operation, blanket cylinder 104 is configured to drive impression cylinder 116 and impression cylinder 116 is configured to drive inker rollers 106 during printing. As indicated above, this may be done through various gears and teeth, or via belt or any other method of driving. For example, blanket gear 122 is coaxial and rotable with blanket cylinder 104, and drives impression cylinder gear 140, which is coaxial and rotable with impression cylinder 116, via meshing engagement between impression cylinder gear teeth 142 and blanket gear teeth 128. Impression cylinder 116, in turn, drives inker gear 130 via second impression cylinder gear 144, and one or more intermediate gears 138.

Referring generally to FIG. 1, FIG. 2, and FIG. 3, driving offset printing unit 100 includes a number of steps, which may be performed in any of a number of orders, and which are not all required. In one embodiment, the user provides (1) plate cylinder 102 so as to support printing plate 110, (2) blanket cylinder 104 so as to support printing blanket 112, (3) inker rollers 106 so as to supply ink to the plate cylinder 102 and blanket cylinder 104, and (4) motor 108 connected to plate cylinder 102. The user places blanket cylinder 104 in rolling engagement with plate cylinder 102 and place inker rollers 106 in rolling engagement with plate cylinder 102. When all appropriate connections are in place, the user activates motor 108, thus driving plate cylinder 102 with motor 108, and driving blanket cylinder 104 with plate cylinder 102. This embodiment also involves driving inker rollers 106 with blanket cylinder 104. Depending on whether a perfecting or non-perfecting operation is desired, the user may repeat the steps for similar equipment on an opposite side of web 114, such that blanket cylinders 104a and 104b engage opposing sides of web 114, or the user may instead provide impression cylinder 116 and drive impression cylinder 116 with blanket cylinder 104. The user drives inker rollers 106 with impression cylinder 116 and engages opposing sides of web 114 with impression cylinder 116 and blanket cylinder 104. Alternatively, the user drives inker rollers 106 with blanket cylinder 104, in either perfecting or in non-perfecting embodiments.

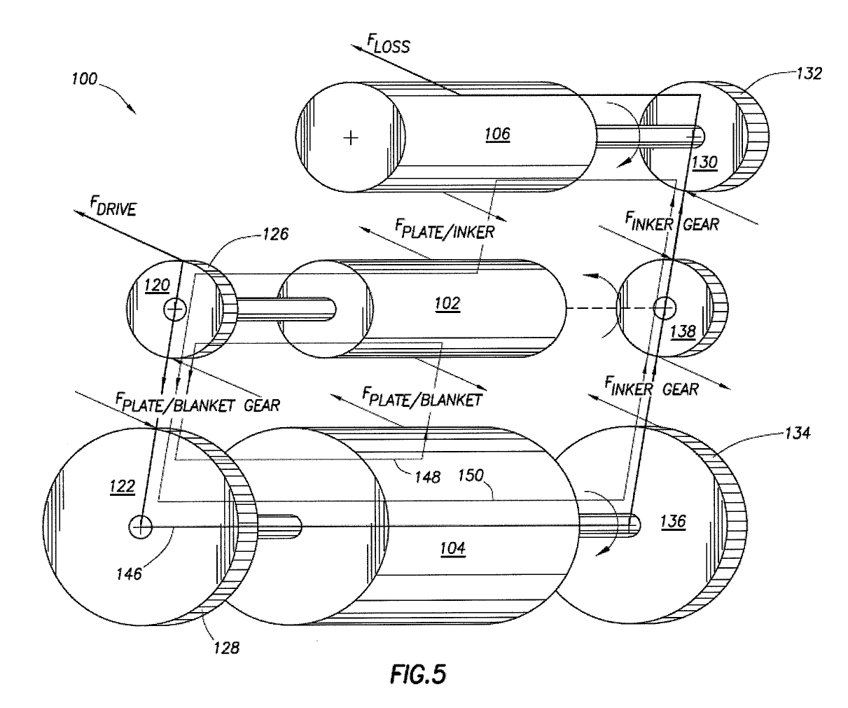

Referring now to FIG. 5, with respect to plate cylinder 102, a positive gain results from both inker rollers 106 and blanket cylinder 104. As illustrated, the improved drive path 146 produces a redistribution of system internal forces, including forces from overspeed blanket path 148 and overspeed inker path 150, which improves loading at the mesh between plate gear 120 and blanket gear 122. Inker gear forces do not change with changes to drive configuration. In the conventional configuration, plate/blanket nip force opposes the loss force and thus decreases the possible plate/blanket gear force. However, in the configuration of FIG. 5, the plate/blanket nip force reinforces the plate/blanket gear force. The various forces are represented by the following equations:

Torque balance for steady state equilibrium about each axis requires:

F_{inkergear}−F_{plate/inker}−Fₗₒₛₛ=0

F_{drive}+F_{plate/inker}+F_{plate/blanket}'F_{plate/blanketgear}=0

F_{plate/blanketgear}−F_{plate/blanket}F_{inkergear}=0

Solving the above three equations for the three gear train forces yields:

F_{inkergear}=Fₗₒₛₛ+F_{plate/inker}

F_{plate/blanketgear}=Fₗₒₛₛ+F_{plate/blanket}+F_{plate/inker}

F_{drive}=Fₗₒₛₛ

One of the many potential advantages of the devices and methods of the present invention, only some of which are herein disclosed, may be reduction in potential printed register variation and doubling arising from relative in-unit displacement between plate cylinder 102 and blanket cylinder 104. Additionally, the present invention provides adequate gear and journal stiffness, thereby making the relative cylinder torsional motion essentially the same as that of the corresponding gears. Moreover, the present invention provides larger nominal contact load between plate gear 120 and blanket gear 122 in normal operation, thereby reducing the potential for dynamic loss of contact while improving the inherent performance margin relative to the performance concern here.

The dimensions, structure, and composition of plate cylinder 102, blanket cylinder 104, inker rollers 106, and impression cylinder 116 are similar to those commonly used in the industry, as would be understood by one or ordinary skill in the art. Likewise, drive motor 108 may be any type of motor known to those skilled in the art; for example, a Servo motor may be used.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. For example, gears may be on either side of any cylinder and one of ordinary skill in the art will understand that a driving relationship may exist in any of a number of configurations. Likewise, relative free surface velocities may be modified to obtain overspeed, neutral, and underspeed relationships between various components, as indicated by the design engineer. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. An offset printing unit, comprising:
a first plate cylinder configured to support a first printing plate during printing;
a first blanket cylinder configured to support a first printing blanket during printing, rollingly engage the first plate cylinder during printing, and rollingly engage a substrate during printing;
at least one first inker roller configured to supply ink to the first plate and blanket cylinders during printing and rollingly engage the first plate cylinder during printing; and
a first motor configured to drive the first plate cylinder during printing.

2. The printing unit according to claim 1, comprising an impression cylinder;
wherein the first blanket cylinder is configured to drive the impression cylinder during printing;
wherein the impression cylinder is configured to drive the at least one inker roller during printing; and
wherein the impression cylinder and the first blanket cylinder are configured to engage opposing sides of the substrate during printing.

3. The printing unit according to claim 1, further comprising:
a second plate cylinder configured to support a second printing plate during printing;
a second blanket cylinder configured to support a second blanket during printing, the second blanket cylinder configured to rollingly engage the second plate cylinder during printing;
at least one second inker roller configured to supply ink to the second plate and blanket cylinders during printing, and rollingly engage the second plate cylinder during printing; and
a second motor configured to drive the second plate cylinder during printing;
wherein the first blanket cylinder and the second blanket cylinder are adapted to engage opposing sides of the substrate during printing.

4. The printing unit according to claim 3:
wherein the first blanket cylinder is configured to drive of the at least one first inker roller during printing;
wherein the second blanket cylinder is configured to drive the at least one second inker roller during printing.

5. The printing unit according to claim 1, wherein a free surface velocity of the first plate cylinder is smaller than a free surface velocity of the first blanket cylinder during printing.

6. The printing unit according to claim 1, wherein a free surface velocity of the first plate cylinder is smaller than a free surface velocity of the at least one first inker roller during printing.

7. The printing unit according to claim 1, comprising:
a first motor gear, coaxial with and rotable with the first motor, and having first motor gear teeth;
a first plate gear, coaxial with and rotable with the first plate cylinder, and having first plate gear teeth configured to meshingly engage the first motor gear teeth and establish a driving connection between the motor and the first plate cylinder;
a first blanket gear, coaxial with and rotable with the first blanket cylinder, and having first blanket gear teeth configured to meshingly engage the first plate gear teeth and establish a driving connection between the first plate cylinder and the first blanket cylinder.

8. The printing unit according to claim 7, further comprising:
a first inker gear, coaxial with and rotable with the at least one first inker roller, and having first inker gear teeth configured to establish a driving connection between the first blanket cylinder and the at least one first inker roller during printing.

9. The printing unit according to claim 8, wherein the first inker gear teeth are configured to meshingly engage teeth on at least one intermediate gear, and wherein the teeth on the intermediate gear are configured to meshingly engage second blanket gear teeth on a second blanket gear during printing.

10. The printing unit according to claim 7, comprising at least one belt drivingly connected to the motor and plate cylinder.

11. The printing unit according to claim 1, wherein the first motor is a Servo motor.

12. A method of driving an offset printing unit comprising a first plate cylinder supporting a first printing plate, a first blanket cylinder supporting a first printing blanket, the first blanket cylinder rollingly engaging the first plate cylinder, at least one first inker roller supplying ink to the first plate and blanket cylinders and rollingly engaging the first plate cylinder, and a first motor connected to the first plate cylinder, the method comprising the steps of:
driving the first plate cylinder with the first motor; and
driving the first blanket cylinder with the first plate cylinder.

13. The method according to claim 12, further comprising the step of driving the at least one first inker roller with the first blanket cylinder.

14. The method according to claim 12, further comprising the steps of:
driving an impression cylinder with the first blanket cylinder;
driving the at least one first inker roller with the impression cylinder; and
engaging opposing sides of a substrate with the impression cylinder and the first blanket cylinder.

15. The method according to claim 12, further comprising the steps of:
driving an impression cylinder with the first blanket cylinder;
driving the at least one first inker roller with the first blanket cylinder; and
engaging opposing sides of a substrate with the impression cylinder and the first blanket cylinder.

16. A method of driving an offset printing unit comprising a first plate cylinder supporting a first printing plate, a second plate cylinder supporting a second printing plate, a first blanket cylinder supporting a first printing blanket, the first blanket cylinder rollingly engaging the first plate cylinder, a second blanket cylinder supporting a second blanket, the second blanket cylinder rollingly engaging the second plate cylinder, at least one first inker roller supplying ink to the first plate and blanket cylinders and rollingly engaging the first plate cylinder, at least one second inker roller supplying ink to the second plate and blanket cylinders and rollingly engaging the second plate cylinder, a first motor connected to the first plate cylinder, and a second motor connected to the second plate cylinder, the method comprising the steps of:
driving the first plate cylinder with the first motor;
driving the second plate cylinder with the second motor;
driving the first blanket cylinder with the first plate cylinder; and
driving the second blanket cylinder with the second plate cylinder.

17. The method according to claim 16, further comprising the steps of:
driving the at least one first inker roller with the first blanket cylinder;
driving the at least one second inker roller with the second blanket cylinder; and
engaging opposing sides of a substrate with the first blanket cylinder and the second blanket cylinder.

18. The method according to claim 1, comprising providing a gear train driving the first plate cylinder.

19. The method according to claim 12, comprising:
providing at least one belt driving the first plate cylinder.
